(19) United States
(12) Patent Application Publication
(10) Pub. No.: US 2018/0052573 A1
(43) Pub. Date: Feb. 22, 2018

(54) INTERACTION WITH A FILE STORAGE SERVICE THROUGH A MESSAGING BOT

(71) Applicant: Microsoft Technology Licensing, LLC, Redmond, WA (US)

(72) Inventors: Can Mehmet Comertoglu, Seattle, WA (US); Jonathan F. Keslin, Kirkland, WA (US); Santiago Buenahora, Seattle, WA (US); Ryan E. Gregg, Seattle, WA (US)

(21) Appl. No.: 15/238,919

(22) Filed: Aug. 17, 2016

(51) Int. Cl. G06F 3/0484; H04L 29/08; G06F 17/28

(52) U.S. Cl. CPC G06F 3/0484; H04L 67/06; G06F 17/28; H04L 67/1097; H04L 67/26

(57) ABSTRACT

A messaging bot provides a natural language interface with a file hosting service. The natural language interface includes other user interface elements, such as buttons, etc. And proactively provides user notifications.

### BACKGROUND

Computer systems are currently in wide use. Some such computer systems provide a hosted service, and one deployed in a remote server environment (such as the cloud).

Among these types of services are cloud-based file hosting services. File hosting services allow users to interact through client devices in order to perform operations within the cloud-based file hosting service. For instance, users can interact with the file hosting service to store files. Retrieve and upload files, perform a wide variety of different file operations, such as sort, filter, search, delete, move, copy, get properties, open, etc.

Users can interact with file hosting services from a variety of different end points, such as through a desktop application, a website, etc. Interacting through multiple different end points means that the user often needs to learn how to use the unique interfaces associated with each end point. These user interfaces are also, often, task-based. Therefore, when a user wishes to perform a multi-step action (such as get a list of files, sort and filter the list, and download a file), this can require an increased cognitive load on the user.

Some current file hosting services attempt to make their interfaces similar to other known interfaces. However, these still involve downloading and learning a new application, in order for them to be used. Also, some current file hosting services use wizards. However, wizards cover relatively limited scenarios and often need additional user training in order to discover and use them.

The discussion above is merely provided for general background information and is not intended to be used as an aid in determining the scope of the claimed subject matter.

### SUMMARY

A messaging bot provides a natural language interface to a file hosting service. The natural language interface includes other user interface elements, such as buttons, etc. And proactively provides user notifications.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a file hosting service architecture.

FIG. 2 is one example of a more detailed block diagram of a bot messaging service.

FIGS. 3A and 3B (collectively referred to herein as FIG. 3) show a flow diagram illustrating one example of the operation of the architecture shown in FIG. 1 and the bot messaging service shown in FIG. 2.

FIG. 4 is a block diagram illustrating one example of a bot-to-bot handoff architecture.

FIG. 5 is a flow diagram illustrating one example of the operation of the architecture shown in FIG. 1 and the bot messaging service shown in FIG. 2 in proactively generating user notifications.

FIGS. 6-8 show examples of mobile devices that can be used in the architectures shown in the previous figures.

FIG. 9 is a block diagram of one example of a computing environment that can be used in the architectures shown in the previous figures.

### DETAILED DESCRIPTION

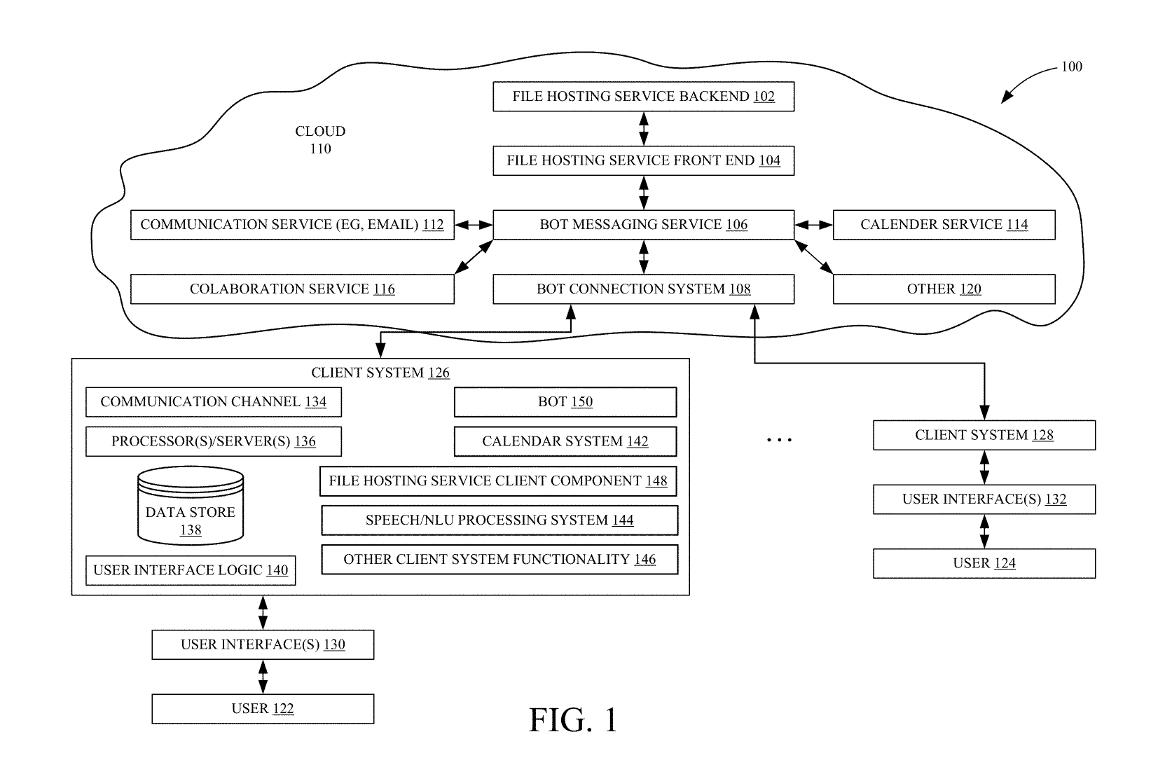

FIG. 1 is a block diagram of one example of a file hosting service architecture 100. Architecture 100 illustratively includes a file hosting service backend 102, file hosting service front end 104, bot messaging service 106 and bot connection system 108. Architecture 100 shows that these items can be deployed in a remote server architecture, such as in cloud 110. It will be noted that other services can also be deployed in cloud 110 (or elsewhere), such as a communication service 112 (e.g., an e-mail service), a calendar service 114, collaboration service 116, or a wide variety of other cloud-based services 120.

FIG. 1 also shows that users 122-124 illustratively use client systems 126-128 in order to access and interact with the various services deployed in cloud 110. Client systems 126 and 128 illustratively generate user interfaces 130 and 132 with user input mechanisms for interaction by users 122 and 124, respectively. Users 122 and 124 thus interact with the user input mechanisms on user interfaces 130-132 in order to control and manipulate client systems 126 and 128, and also in order to access, control and manipulate the services deployed in cloud 110.

Client systems 126 and 128 may be similar or different. For purposes of the present discussion, it will be assumed that they are similar, and only one of them (client system 126) will be described in more detail.

In the example shown in FIG. 1, client system 126 illustratively includes one or more communication channels 134, one or more processors or servers 136, data store 138, user interface logic 140, calendar system 142, speech processing system 144, and it can include a wide variety of other client system functionality 146. FIG. 1 also shows that client system 126 can include a file hosting service client component 148 that interacts with the file hosting service deployed in cloud 110. As will be described in greater detail below, one or more bots 150 can be deployed on the client systems 126-128 or in the cloud 110, or elsewhere, and they can be used to generate user interfaces 130 for interaction by user 122. FIG. 1 shows that bot 150 is deployed on client system 126 for the sake of example only, and it will be appreciated that it can be deployed in cloud 110 (such as in bot messaging service 106, as described below) or in other locations, other than those shown in FIG. 1.

Before describing the operation of architecture 100 in more detail, a brief description of some of the items in architecture 100, and their operation, will first be provided. File hosting service backend 102 illustratively exposes interfaces through file hosting service front end 104. Other applications or users can interact with the interfaces in order to perform file operations on files that are hosted by service backend 102. Backend 102 can, itself, include a data store for storing the files, or it can communicate with a data store that may be deployed in cloud 110, or elsewhere.

In one example, client systems 126-128 can interact with the interfaces exposed by file hosting service front end 104 in order to perform file operations. In another example, bot messaging service 106 can be connected, through bot connection system 108, to one of the communication channels 134 that is used in the client systems. Bot messaging service 106 can then either interact with a bot 150 on client system 126, or it can, itself, host a bot that client system 126 can interact with. The bot (wherever it is located) illustratively exposes natural language interfaces. User 122 can use the natural language interfaces exposed by the bot to interact with the interfaces exposed by file hosting service front end 104, using a natural language input (such as a natural language query, a natural language command or instruction, etc.). The bot may also illustratively expose other user interface controls (such as buttons, text boxes, etc.) that user 122 can interact with as well.

Bot connection system 108 illustratively identifies the particular type of communication channel 134 that a given client system 126 is using and connects bot messaging service 106, through that communication channel 134, to client system 126. The communication channel may be a wide variety of different types of channels, such as a messaging system in a social network, an electronic mail system, an instant messaging (SMS) system, a web-based system (such as a chat system), etc. Bot connection system 108 illustratively routes messages and manages the state of the bot interactions with the user 122 and can perform session tracking services (such as translation, etc.) on a per-user, per-bot basis.

It will also be noted that, as described below, bot messaging service 106 can interact with other services that user 122 is using, such as the user's communication service 112, the calendar service 114 of the user, any collaboration services 116 that the user may be using, etc. It can do this in order to perform multi-step actions that may cross over multiple different services.

By way of example, it may be that the user provides a natural language input such as “Find the presentation I made at the meeting yesterday and e-mail it to John Doe.” This type of multi-step action would involve the bot analyzing the natural language input to identify the particular steps that are to be performed in order to accomplish the desired action. This would involve accessing the user's calendar through calendar service 114 to identify “yesterday's meeting”, and to identify the particular presentation file that was provided at that meeting. It would then involve the bot messaging service 106 accessing the user's communication service (e.g., the contacts list in the user's e-mail service) to identify an e-mail address of “John Doe” and then to attach and send the identified file to the identified recipient. This, of course, is only one example and a wide variety of other multi-step actions can be taken (either within a system, or across different systems) as well.

On client system 126, user interface logic 140 illustratively generates user interfaces 130 and detects user interactions with those interfaces. For instance, where the user interface is a natural language interface, it may be that user 122 either speaks or types a natural language query, command, etc., into the interface. User interface logic 140 detects this and provides it to any other items in client system 126 or in cloud 110, for processing. For instance, where it is a natural language speech input, that input may be provided to speech processing system 144 which generates a semantic or linguistic meaning associated with the speech input, and which may also identify the particular steps to take in order to perform the desired action.

File hosting service client component 148 may be a client component of the file hosting service deployed on cloud 110. Some such services use client components and, if one is used, it can be deployed on client 126 as file hosting service client component 148. Calendar system 142 illustratively interacts with calendar service 114 in order to allow user 122 to perform calendar operations on the user's calendar. Such operations may include scheduling meetings or calls, setting an appointment among a wide variety of other calendaring operations.

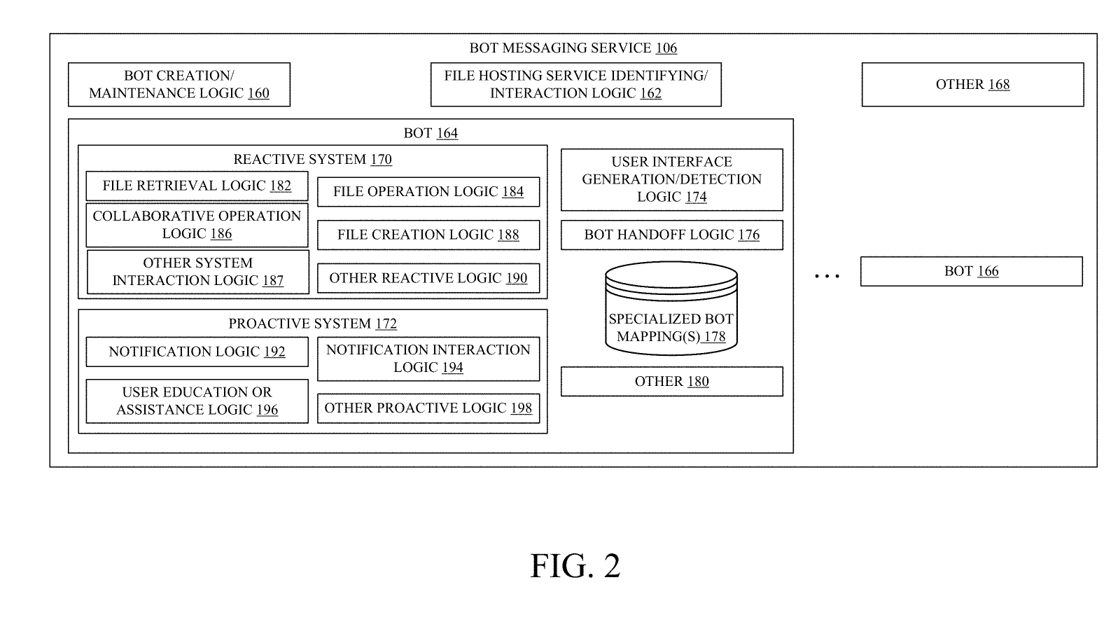

Bot 150 is shown on client system 126 because, in one example, it can be deployed on client system 126 and communicate through bot connection system 108 to other parts of bot messaging service 106 (some of which are described in greater detail below with respect to FIG. 2). In another example, bot 150 is deployed in bot messaging service 106 and it provides a natural language interface that is surfaced for user 122 of client system 126 by user interface logic 140.

FIG. 2 is a block diagram showing one example of bot messaging service 106, in more detail. In the example shown in FIG. 2, bot messaging service 106 can include bot creation/maintenance logic 160, file hosting service identifying/interaction logic 162, one or more bots 164-166, and it can include a wide variety of other items 168. For purposes of the present discussion, a bot (such as bots 150, 164 and 166) are software applications that run automated tasks (such as scripts) over a wide area network (such as the Internet). Examples of bots can include relatively simple Internet relay chat (IRC)-controlled networks, private peer-to-peer networks and web-based command and control versions.

Bot 164 illustratively includes a reactive system 170, a proactive system 172, user interface generation logic 174, bot handoff logic 176, specialized bot mappings 178 that can be stored in a data store, and they can include a wide variety of other items 180. Again, bots 164 and 166 can be the similar or different.

Reactive system 170 illustratively uses user interface generation logic 174 in order to generate user interface elements that user 122 can interact with in order to control and manipulate bot 164. In one example, it reacts to those inputs in order to perform various different operations within the file hosting service that uses backend 102 and front end 104.

For instance, reactive system 170 can include file retrieval logic 182 that generates user interfaces through user interface generation logic 174 that user 122 can use in order to perform file retrieval operations. The file retrieval operations can include controls that allow the user to perform such things as search, get recent files, perform relatively complicated queries such as “get me the slide show I was working on last week”, “get me the photos I took it Italy”, “get me the files that are larger than 100 MB that I haven't looked at lately”, etc. User interface generation/detection logic 176 detects user interaction with these user input mechanisms, and, in response, file retrieval logic 182 controls file hosting service identifying/interaction logic 162 to identify the particular file hosting service that is to be interacted with, and to interact with the interfaces exposed by that file hosting service in order to perform the desired action.

Similarly, file operation logic 184 controls user interface logic 174 to generate user input mechanisms that user 122 can interact with in order to perform file operations. Such operations can include sort, filter, search, delete, rename, move, copy, get properties (such as length, word count, pages, etc.), open, download, and perform conditional statements (such as “if a file is larger than 2 MB, delete it.”). When the user interacts with any of those user input mechanisms, logic 184 controls file hosting service identifying/interaction logic 162 to identify the particular file hosting service (if it has not already been identified) and to interact with its exposed interfaces in order to perform the desired operation.

Collaborative operation logic 186 and file creation logic 188 can perform in similar ways in order to expose user interfaces that allow user 122 to perform collaborative operations on files hosted by the file hosting service, and to create files that will be hosted by the file hosting service, respectively. The collaborative operations may include such things as share via e-mail, share via a link, share via social media, etc. Logic 186 can use other services (such as communication service 112, calendar service 114, etc.), to disambiguate requests. For instance, if user 122 provides a natural language input such as “share that file with Cindy”, logic 186 controls logic 162 to access the contact list in communication service 112 to identify the contact that has a name “Cindy”. It then shares the identified file with “Cindy” at her e-mail address.

The commands that are enabled by file creation logic 188 includes such things as upload, create a new file, manage a contextual state across messages in a conversation (such as, “get a list of files”, “sort by name”, “filter to word processing files”).

Other system interaction logic 187 can include any logic needed to perform steps in any other system, other than the file hosting service. For instance, logic 187 can interact with interfaces exposed by systems 112, 114, 116, 120, etc.

Reactive system 170 can include a wide variety of other reactive logic 190 as well. This is also contemplated herein.

Proactive system 172 illustratively includes notification logic 192, notification interaction logic 194, user education or assistance logic 196, and it can include a wide variety of other proactive logic 198. Notification logic 192 illustratively receives and surfaces for user 122 any notifications that the user 122 should have. For instance, notifications may be notifications about the user's account for any of the services shown in FIG. 1 (e.g., that the user is about to reach his or her storage quota, etc.). The notifications can be about collaboration in collaboration service 116 (e.g., that something has been shared with user 122). The notifications can be about content (such as a notification to see photos taken on this day last year).

In one example, logic 192 generates the notifications with user input mechanisms that allow user 122 to interact with the notifications. For instance, a notification that indicates that the user is running low on storage may include an “upgrade” button. When the user actuates the upgrade button, the bot 164 may interact with user interfaces on the user's storage service in order to increase the storage capacity that is useable by the user. Notification interaction logic 194 detects user interaction with the “upgrade” button and controls logic 162 to interact with the appropriate interfaces in order to increase the amount of storage available to user 122. Notification logic 192 can then generate an appropriate notification such as “OK, you have 2 GB more now!”

User education or assistance logic 196 can generate educational information to the user through conversational interactions. For instance, assume that user 122 is searching for something, and bot 164 performs the search. Logic 196 can then generate a message such as “Did you know that you can search for photo contents?” “Try searching for ‘dogs’.”, etc. Proactive system 172 can include a wide variety of other proactive logic 198, to perform other proactive operations as well.

It may also be that some of the desired actions that user 122 wishes to take may be relatively specific for a given workload (or application). By way of example, assume that user 122 first wishes to locate a particular spreadsheet file. It may be that a general purpose bot can perform the steps of searching for, locating, and surfacing that spreadsheet file. Assume also, however, that the user wishes to perform a specific operation on that file, such as to add a column, etc. In that case, bot handoff logic 176 may determine that a specialized bot, that is specifically configured to interact in a detailed way with a specific workload (such as with the spreadsheet application in which the spreadsheet was authored), is better suited to perform the specific operation. Bot handoff logic 176 can then hand over further processing in the desired action to the specialized bot. In doing so, it may access specialized bot mappings 178 to identify the particular specialized bot that should be invoked in order to perform the specific steps. This is described in greater detail below.

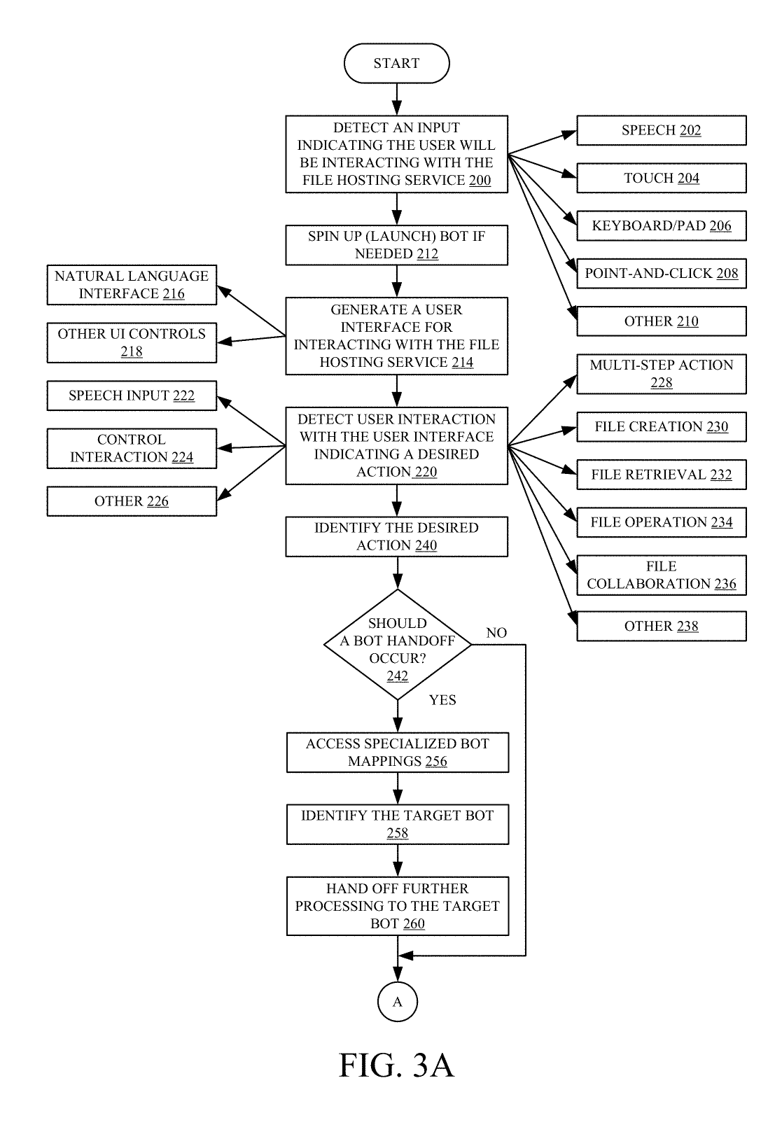

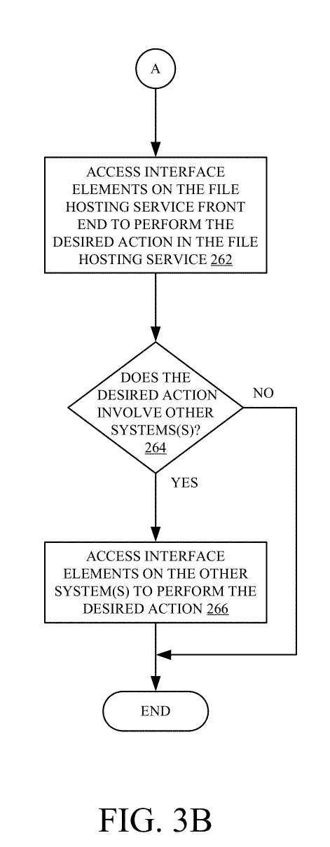

FIGS. 3A and 3B (collectively referred to herein as FIG. 3) show a flow diagram illustrating one example of the operation of architecture 100 and bot messaging service 106 in more detail. FIGS. 1-3 will now be described in conjunction with one another.

User interface logic 140 first detects that user 122 has provided an input indicating that the user will be interacting with the file hosting service through file hosting service front end 104. This is indicated by block 200 in FIG. 3. The user input can be a speech input 202 that is provided to speech processing system 144, or to a remote speech processing system (that may be located in cloud 110 or elsewhere). The speech processing system generates a linguistic or semantic meaning for the speech input and provides it either to file hosting service client component 148 (which provides it through bot connection system 108 to bot 164 in bot messaging service 106) or directly to bot connection system 108 (where there is no client component 148). The input can also be a touch input 204 which indicates that the user 122 is attempting to access the file hosting service. It can be a keyboard or keypad input 206, an input with a point and click device, as indicated by block 208, or any of a wide variety of other user inputs 210.

In response, bot creation/maintenance logic 160 illustratively spins up or launches bot 164, if needed. For instance, it may be that a plurality of different bots are already operating or have already been launched, and one of the existing bots can be used. Alternatively, it may be that another bot needs to be launched, in which case logic 160 does this. Spinning up or launching a bot, if needed, is indicated by block 212 in the flow diagram of FIG. 3.

For the sake of the present example, it will be assumed that bot creation/maintenance logic 160 launched bot 164 for interaction by user 122. In that case, user interface generation/detection logic 174, in bot 164, generates a user interface so that user 122 can interact with the file hosting service. This is indicated by block 214 in FIG. 3. In one example, the interface is a natural language interface 216 that allows the user to enter a natural language query or command The natural language user interface may be a speech enabled interface so that the user can speak the natural language input, or it may be a search box or text box in which the user can type or otherwise input the natural language input. The user interface may also include other user interface controls 218, such as buttons, drop down boxes, icons, or any of a wide variety of other user interface controls.

User interface generation/detection logic 174 then detects user interaction with the user interface indicating that user 122 wishes to perform a desired action in the file hosting service. This is indicated by block 220 in FIG. 3. In one example, for instance, logic 174 detects a speech input 222. In another example, it detects user interaction with a UI control on the user interface, as indicated by block 224. It can detect user interaction in a wide variety of other ways 226 as well.

The desired action can also take a variety of different forms. In one example, for instance, it is a multi-step action 228. The multi-step action 228 may include multiple steps within the file hosting service. It may also include multiple steps both inside the file hosting service and in other services, such as communication service 112, calendar service 114, collaboration service 116, or other services 120. For instance, the natural language input may be “Send the slide presentation that I made at my 9:00 meeting yesterday to Cindy.” In that example, the natural language input indicates a multi-step desired action that involves not only the file hosting service, but also calendar service 114 and communication service 112. The steps would include using the calendar service 144 to identify the user's meeting at 9:00 the previous day, using the file hosting service to identify a slide presentation file that was presented at that meeting, identifying “Cindy” in the user contacts in communication service 112, and then sending the identified file to the identified person, using communication service 112.

The desired action may include a file creation action 230 in which user 112 desires to create a file within the file hosting service. It may include a file retrieval action 232 such as where user 122 is searching for a file, wishes to download a file, etc. It may include any of a wide variety of other file operations 234, some of which are mentioned above, and it can include a file collaboration operation 236. In that case, bot 164 will also interact with collaboration service 116. It will be noted that the desired action can include a wide variety of other actions 238 as well.

Bot 164 then identifies the desired action based upon the user input. This is indicated by block 240 in the flow diagram of FIG. 3. This can be done in a wide variety of different ways. For instance, bot 164 can access a natural language understanding system, a set of mappings, rules, or other models that correlate the natural language input to one or more desired actions. It can identify the desired action in a wide variety of other ways as well.

Once the desired action is identified, or at any time during processing of the desired action, bot handoff logic 176 determines whether further processing to accomplish the desired action should be handed to another bot, such as a specialty bot. This is indicated by block 242 in the flow diagram of FIG. 3.

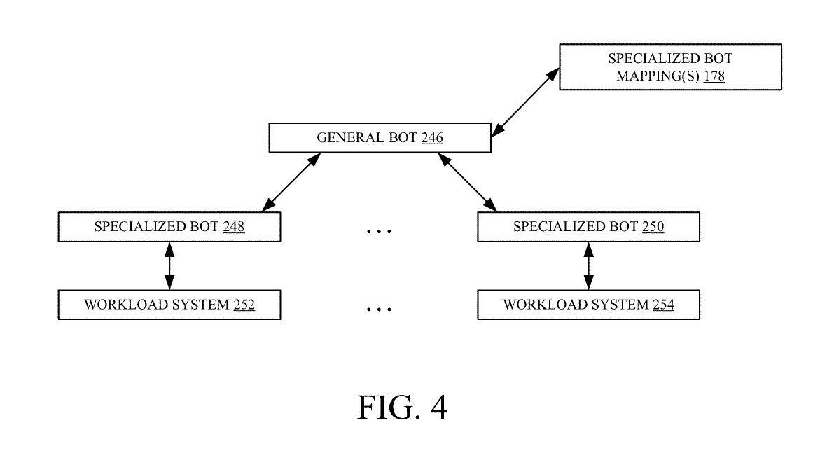

FIG. 4 shows one example of a bot handoff architecture 244 which can comprise bot handoff logic 176. In one example, architecture 244 includes a general bot 246 that accesses specialized bot mappings 178 (also shown in FIG. 2) and a plurality of specialized bots 248-250. Each of the specialized bots 248-250 are illustratively trained or otherwise configured to interact with a different workload system 252-254. For instance, workload system 252 may be a spreadsheet application (or spreadsheet system). In that case, specialized bot 248 may be highly trained to perform specialized and detailed actions within the spreadsheet application of workload system 252. Thus, in one example, general bot 246 receives the desired action that was identified based on the user input. It accesses specialized bot mappings 178 that map from desired actions to specialized bots 248-250. Accessing the specialized bot mappings is indicated by block 256 in the flow diagram of FIG. 3.

Based on those mappings, general bot 246 identifies a target bot (such as one of specialized bots 248-250) from the mappings. This is indicated by block 258 in the flow diagram of FIG. 3. Once a target bot is identified, general bot 246 hands off further processing to the target bot so that it can perform the detailed operations on the corresponding workload. This is indicated by block 260 in the flow diagram of FIG. 3.

Again, by way of example, assume that the natural language input indicates that, at least one step in the desired action includes performing a relatively detailed operation within a spreadsheet application (such as adding a column, etc.). General bot 146 may perform other, more general steps in the desired action, such as locating a spreadsheet file that is to be operated on, retrieving it, etc. However, when it comes to the more detailed operations within the spreadsheet application, it may access specialized bot mappings 178 to identify that these types of actions may be more accurately or effectively handled by specialized bot 248. It thus provides instructions to the specialized bot 248 to perform the detailed steps, within the desired action. For instance, it may provide instructions to specialized bot 248 to add a column to the open spreadsheet file, by interacting with a spreadsheet workload system 252.

At some point, the bot (either a general bot or a specialized bot or both) accesses interface elements on the file hosting service front end 104 to perform the desired action or actions in the file hosting service. This is indicated by block 262 in the flow diagram of FIG. 3. By way of example, the reactive system 170 in bot 164 may illustratively interact with interface elements on an API exposed by file hosting service front end 104, to perform the desired action. If the desired action is a retrieval action, a file operation, a collaborative action, or a file creation action, then the corresponding logic 182, 184, 186 or 188, illustratively interacts with the appropriate API on the file hosting service front end 104 to perform the corresponding action. File hosting service front end 104 can then illustratively interact with file hosting service backend 102 so that the operation is carried out.

Other system interaction logic 187 in bot 164 then determines whether the desired action may involve any other systems. This is indicated by block 264. If so, the appropriate logic accesses the interface on that service on the other system (e.g., on another service) to perform the steps of the desired action within that service. This is indicated by block 266.

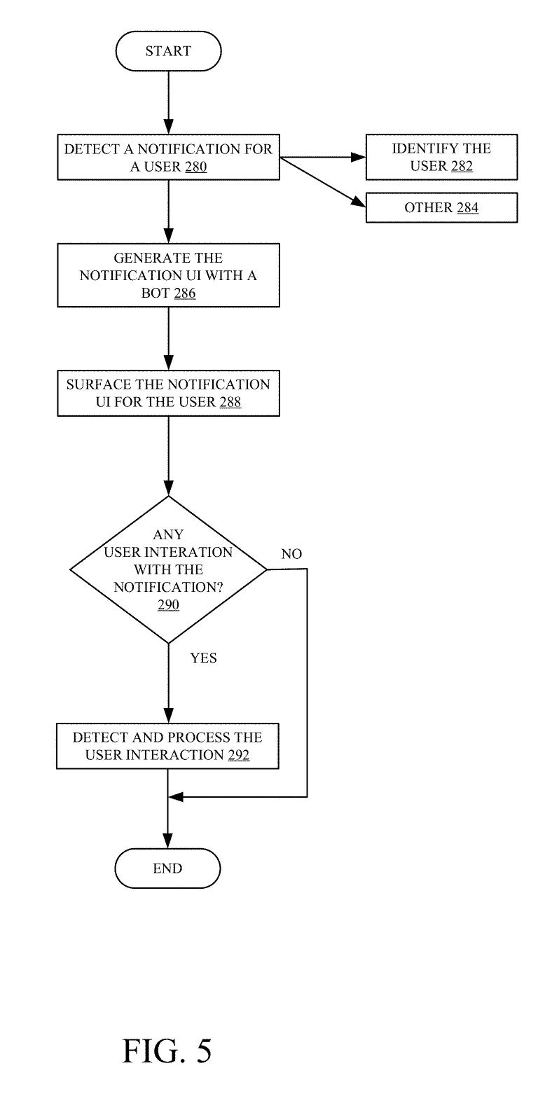

FIG. 5 is a flow diagram illustrating one example of the operation of proactive system 172 in bot 164 in notifying users of notifications. Proactive system 172 may choose to send user notifications via proactive bot messages based on whether the user has previously interacted with the bot, whether the user has interacted with the bot recently, and/or whether the user has attached their identity on the messaging system that the bot is running on to their account on the file hosting service (e.g. attached their social network account to their file hosting service account).

Proactive system 172 first detects that a notification has been generated (or has risen) that user 122 is to receive. Detecting a notification for surfacing to a user is indicated by block 280 in the flow diagram of FIG. 5. The notification can be detected by a wide variety of other items as well. For instance, in the computing system architecture in which the present bot messaging service 106 is deployed, there may be a notification system that raises notifications and identifies users or other endpoints where the notifications are to be provided. Identifying a user that is to receive the notification can be performed in a wide variety of other ways as well. Identifying the user is indicated by block 282 and detecting a notification in other ways is indicated by block 284.

Notification logic 192 in proactive system 172 then generates a notification user interface, representing the notification, for surfacing to the user. This is indicated by block 286. The notification user interface may include not only display elements that describe the notification, but it may also include interactive elements, such as controls, natural language input mechanisms, or other user input mechanisms, that the user can interact with on the notification user interface.

Notification logic 192 then surfaces the notification user interface for the user. This is indicated by block 288. In one example, notification logic 192 provides the notification to the user interface logic 140 on the client system 126 corresponding to the user 122. User interface logic 140, itself, displays the user interface display for the user. In another example, notification logic 192 can use user interface generation/detection logic 174 in bot 164 to, itself, generate the display of the notification user interface. The notification user interface can be surfaced for the user in other ways as well.

The notifications, themselves, may also provide a natural language interface that user 122 can interact with. Further, if there are controls on the notification user interface, then user 122 may interact with those controls. By way of example, it may be that the notification is alerting user 122 to the fact that the user is nearly out of available storage. It may also include an “upgrade” control that can be actuated by the user in order to automatically increase the available storage for the user or a natural language interface which allows the user to enter a natural language input, such as “Please upgrade my storage capacity.”. In one example, user interface generation/detection logic 174 detects user interaction with the user actuatable display element on the notification user interface or with the natural language interface and generates instructions to perform any actions corresponding to that user action, within the file hosting service. Determining whether the user has interacted with any controls or natural language interface or other elements on the notification user interface, and then detecting and processing that user interaction is indicated by blocks 290 and 292 in the flow diagram of FIG. 5. It will also be noted that, when a user is using a bot 164 to interact with a file hosting service, file hosting service identifying/interaction logic 162 can facilitate interaction of bot 164 with any of a variety of different file hosting services. For instance, it may identify the particular file hosting service (where there are a plurality of different file hosting services that can be accessed) in which the desired action is to be taken. It can then access functionality that interacts with the application programming interface exposed by the identified file hosting service, in order to perform the desired action. In this way, user 122 can interact with any of a plurality of different file hosting services, using a natural language input, even where the different file hosting services may expose different APIs and use different methods to accomplish actions. Bot messaging service 106 handles the interaction, so that user 122 need not learn multiple different interfaces for the different file hosting services, or other services. The bot messaging service 106 can thus be a single natural language interface to a plurality of different cloud-based services, which normally use different interfaces for interaction.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will also be noted that the present discussion has referred to a cloud-based service or architecture. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

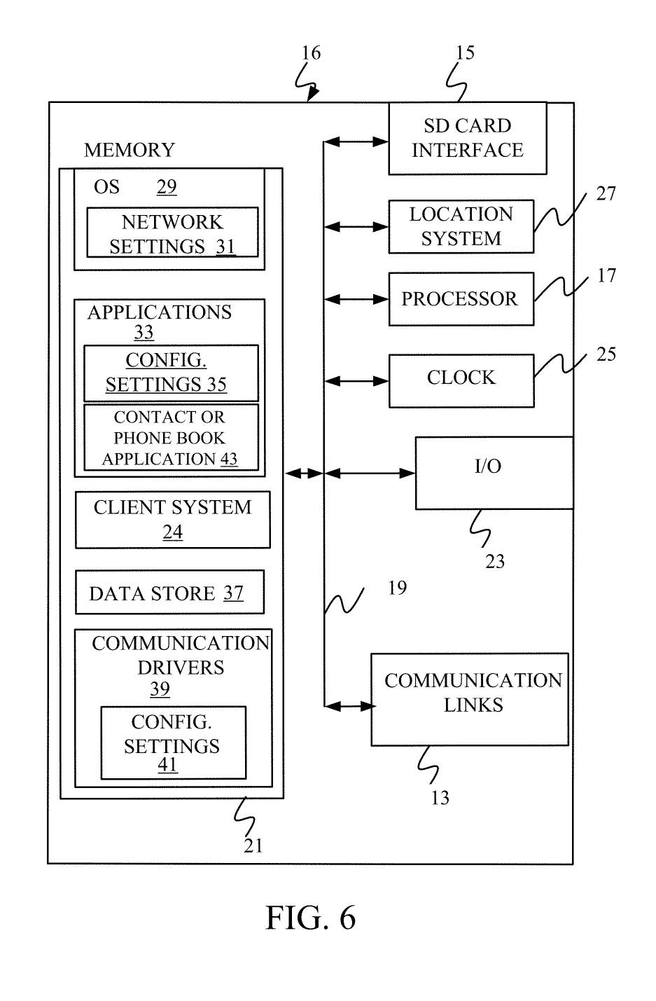

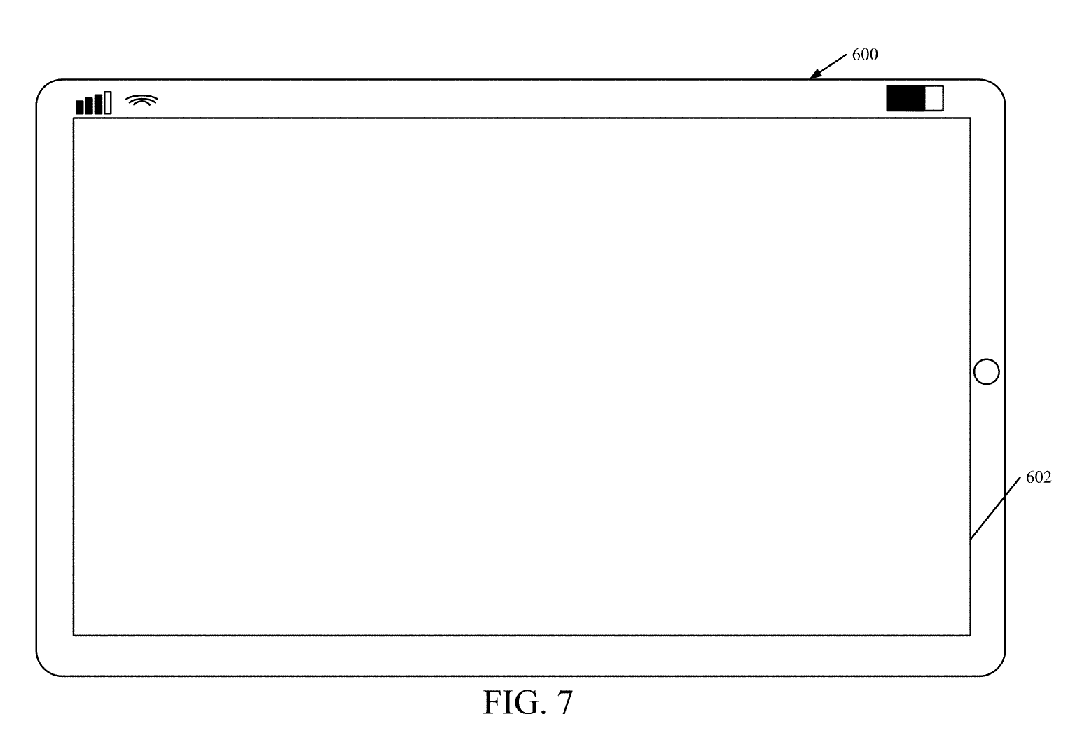

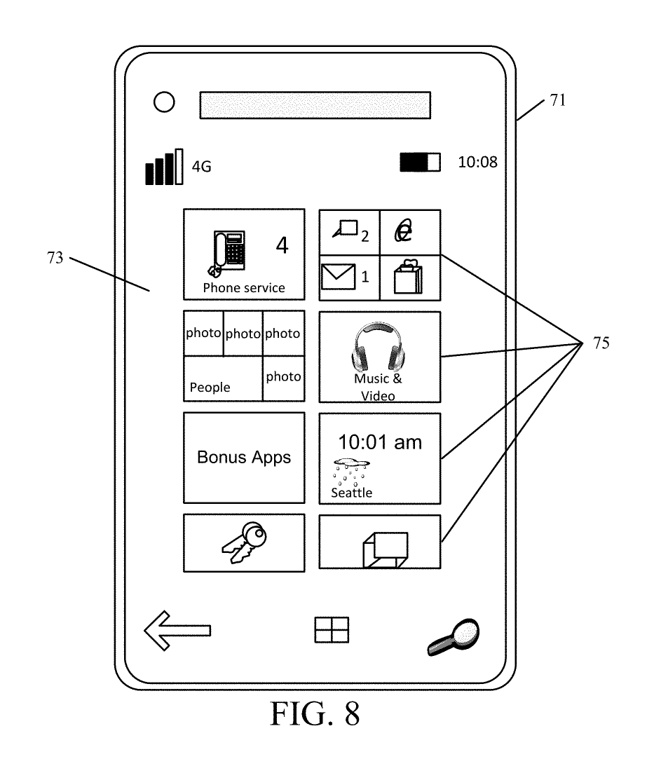

FIG. 6 is a simplified block diagram of one illustrative example of a handheld or mobile computing device that can be used as a user's or client's hand held device 16, in the architecture shown above, and in which the present system (or parts of it) can be deployed. FIGS. 7-8 are examples of handheld or mobile devices.

FIG. 6 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from previous Figures) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of file hosting service client component 148. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one example in which device 16 is a tablet computer 600. In FIG. 6, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 8 shows that the device can be smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

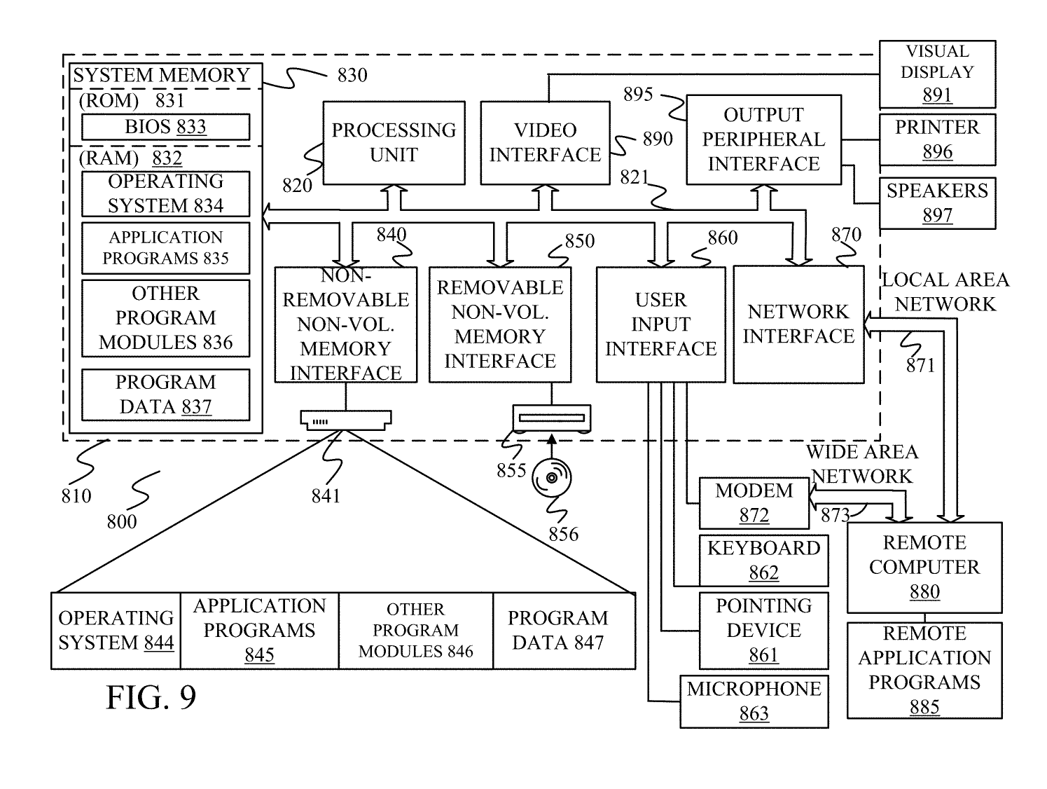

FIG. 9 is one example of a computing environment in which architecture 100, or parts of it, (for example) can be deployed. With reference to FIG. 9, an example system for implementing some embodiments includes a general-purpose computing device in the form of a computer 810. Components of computer 810 may include, but are not limited to, a processing unit 820 (which can comprise processors or servers from previous Figures), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to previous Figures can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

a bot messaging service that runs a bot that generates a natural language interface for user interaction with a file hosting service and, in response to detected user inputs through the natural language interface, indicative of a desired action, identifies a file hosting service to interact with, of a plurality of different file hosting services, and interacts with an interface exposed by the identified file hosting service to perform steps to accomplish the desired action in the identified file hosting service; and

a bot connection system that is configured to connect the bot with a communication channel on a client system.

Example 2 is the computing system of any or all previous examples wherein the bot messaging system comprises:

file hosting service identifying logic that identifies the file hosting service to interact with, based on the detected user inputs; and

file hosting service interaction logic that interacts with the interface exposed by the identified file hosting service to perform the steps.

Example 3 is the computing system of any or all previous examples wherein the bot comprises:

a reactive system configured to determine the steps to take to accomplish the desired action and control the file hosting service interaction logic to perform the steps in the identified file hosting service.

Example 4 is the computing system of any or all previous examples wherein the bot further comprises:

a proactive system that proactively generates proactive user interface information for surfacing to the user.

Example 5 is the computing system of any or all previous examples wherein the proactive system generates the proactive user interface information with a natural language user input mechanism that is actuated to perform an action based on the proactive user interface information.

Example 6 is the computing system of any or all previous examples wherein the proactive system comprises:

notification logic that identifies a notification to be surfaced to the user and generates the proactive user interface information indicative of the notification; and

notification interaction logic configured to detect user interaction with the natural language user input mechanism and to control the bot to perform the action based on the proactive user interface information indicative of the notification.

Example 7 is the computing system of any or all previous examples wherein the bot comprises:

bot handoff logic configured to access specialized bot mappings, that map steps to specialized bots, and hand off processing of the desired action to an identified specialized bot, based on the steps and the specialized bot mappings.

Example 8 is the computing system of any or all previous examples wherein the reactive system comprises:

other system interaction logic configured to detect that the desired action includes one or more steps to be performed in another system, other than the file hosting service, and to interact with an interface exposed by the other system to perform the one or more steps.

Example 9 is the computing system of any or all previous examples wherein the reactive system comprises:

file creation logic configured to detect the desired action is a file creation action and control the file hosting service interaction logic to execute steps in the identified file hosting service to perform the file creation action.

Example 10 is the computing system of any or all previous examples wherein the reactive system comprises:

file retrieval logic configured to detect the desired action is a file retrieval action and control the file hosting service interaction logic to execute steps in the identified file hosting service to perform the file retrieval action.

Example 11 is the computing system of any or all previous examples wherein the reactive system comprises:

file operation logic configured to detect the desired action is a file operation action indicative of an action to be performed within a file and control the file hosting service interaction logic to execute steps in the identified file hosting service to perform the file operation action.

Example 12 is the computing system of any or all previous examples wherein the reactive system comprises:

collaborative operation logic configured to detect that the desired action is a collaborative action relative to a file in the file hosting service, and to interact with an interface exposed by a collaboration system to perform the collaborative action in the collaboration system.

Example 13 is a computer-implemented method, comprising:

running a bot that generates a natural language interface for user interaction with a file hosting service;

detecting a user input through the natural language interface, indicative of a desired action;

in response to the detected user input, identifying a file hosting service to interact with, of a plurality of different file hosting services;

performing steps with the bot to accomplish the desired action in the identified file hosting service, by interacting with an interface exposed by the identified file hosting service; and

proactively generating proactive user interface information for surfacing to the user.

Example 14 is the computer-implemented method of any or all previous examples wherein generating the proactive user interface information comprises:

identifying a notification to be surfaced to the user;

generating the proactive user interface information indicative of the notification, including a user input mechanism;

detect user actuation of the user input mechanism; and

controlling the bot to perform the action based on the proactive user interface information indicative of the notification.

Example 15 is the computer-implemented method of any or all previous examples and further comprising:

accessing, with the bot, specialized bot mappings, that map steps to specialized bots; and

handing off processing of the desired action to an identified specialized bot, based on the steps and the specialized bot mappings.

Example 16 is the computer-implemented method of any or all previous examples wherein performing steps with the bot to accomplish the desired action comprises:

detecting that the desired action includes one or more steps to be performed in another system, other than the file hosting service; and

interacting with an interface exposed by the other system to perform the one or more steps.

Example 17 is the computer-implemented method of any or all previous examples wherein performing steps with the bot to accomplish the desired action comprises:

detecting that the desired action is a collaborative action relative to a file in the file hosting service; and

interacting with an interface exposed by a collaboration system to perform the collaborative action in the collaboration system.

Example 18 is a bot messaging service, comprising:

a bot having a reactive system that generates a natural language interface for user interaction with a file hosting service and, in response to detected user inputs through the natural language interface indicative of a desired action, identifies a file hosting service to interact with, of a plurality of different file hosting services, identifies steps to perform to accomplish the desired action in the identified file hosting service, and interacts with an interface exposed by the identified file hosting service to perform the steps, the bot having a proactive system that proactively generates proactive user interface information for surfacing to the user; and

a bot connection system that is configured to connect the bot with a communication channel on a client system.

Example 19 is the bot messaging system of any or all previous examples and further comprising:

bot handoff logic configured to access specialized bot mappings, that map steps to specialized bots, and hand off processing of the desired action to an identified specialized bot, based on the steps and the specialized bot mappings.

Example 20 is the bot messaging system of any or all previous examples wherein the reactive system of the bot further comprises:

other system interaction logic configured to detect that the desired action includes one or more steps to be performed in another system, other than the file hosting service, and to interact with an interface exposed by the other system to perform the one or more steps.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a bot messaging service that runs a bot that generates a natural language interface for user interaction with a file hosting service and, in response to detected user inputs through the natural language interface, indicative of a desired action, identifies a file hosting service to interact with, of a plurality of different file hosting services, and interacts with an interface exposed by the identified file hosting service to perform steps to accomplish the desired action in the identified file hosting service; and
a bot connection system that is configured to connect the bot with a communication channel on a client system.

2. The computing system of claim 1 wherein the bot messaging system comprises:
file hosting service identifying logic that identifies the file hosting service to interact with, based on the detected user inputs; and
file hosting service interaction logic that interacts with the interface exposed by the identified file hosting service to perform the steps.

3. The computing system of claim 2 wherein the bot comprises:
a reactive system configured to determine the steps to take to accomplish the desired action and control the file hosting service interaction logic to perform the steps in the identified file hosting service.

4. The computing system of claim 3 wherein the bot further comprises:
a proactive system that proactively generates proactive user interface information for surfacing to the user.

5. The computing system of claim 4 wherein the proactive system generates the proactive user interface information with a natural language user input mechanism that is actuated to perform an action based on the proactive user interface information.

6. The computing system of claim 5 wherein the proactive system comprises:
notification logic that identifies a notification to be surfaced to the user and generates the proactive user interface information indicative of the notification; and
notification interaction logic configured to detect user interaction with the natural language user input mechanism and to control the bot to perform the action based on the proactive user interface information indicative of the notification.

7. The computing system of claim 2 wherein the bot comprises:
bot handoff logic configured to access specialized bot mappings, that map steps to specialized bots, and hand off processing of the desired action to an identified specialized bot, based on the steps and the specialized bot mappings.

8. The computing system of claim 3 wherein the reactive system comprises:
other system interaction logic configured to detect that the desired action includes one or more steps to be performed in another system, other than the file hosting service, and to interact with an interface exposed by the other system to perform the one or more steps.

9. The computing system of claim 3 wherein the reactive system comprises:
file creation logic configured to detect the desired action is a file creation action and control the file hosting service interaction logic to execute steps in the identified file hosting service to perform the file creation action.

10. The computing system of claim 3 wherein the reactive system comprises:
file retrieval logic configured to detect the desired action is a file retrieval action and control the file hosting service interaction logic to execute steps in the identified file hosting service to perform the file retrieval action.

11. The computing system of claim 3 wherein the reactive system comprises:
file operation logic configured to detect the desired action is a file operation action indicative of an action to be performed within a file and control the file hosting service interaction logic to execute steps in the identified file hosting service to perform the file operation action.

12. The computing system of claim 3 wherein the reactive system comprises:
collaborative operation logic configured to detect that the desired action is a collaborative action relative to a file in the file hosting service, and to interact with an interface exposed by a collaboration system to perform the collaborative action in the collaboration system.

13. A computer-implemented method, comprising:
running a bot that generates a natural language interface for user interaction with a file hosting service;
detecting a user input through the natural language interface, indicative of a desired action;
in response to the detected user input, identifying a file hosting service to interact with, of a plurality of different file hosting services;
performing steps with the bot to accomplish the desired action in the identified file hosting service, by interacting with an interface exposed by the identified file hosting service; and
proactively generating proactive user interface information for surfacing to the user.

14. The computer-implemented method of claim 13 wherein generating the proactive user interface information comprises:
identifying a notification to be surfaced to the user;
generating the proactive user interface information indicative of the notification, including a user input mechanism;
detect user actuation of the user input mechanism; and
controlling the bot to perform the action based on the proactive user interface information indicative of the notification.

15. The computer-implemented method of claim 13 and further comprising:
accessing, with the bot, specialized bot mappings, that map steps to specialized bots; and
handing off processing of the desired action to an identified specialized bot, based on the steps and the specialized bot mappings.

16. The computer-implemented method of claim 13 wherein performing steps with the bot to accomplish the desired action comprises:
detecting that the desired action includes one or more steps to be performed in another system, other than the file hosting service; and
interacting with an interface exposed by the other system to perform the one or more steps.

17. The computer-implemented method of claim 13 wherein performing steps with the bot to accomplish the desired action comprises:
detecting that the desired action is a collaborative action relative to a file in the file hosting service; and
interacting with an interface exposed by a collaboration system to perform the collaborative action in the collaboration system.

18. A bot messaging service, comprising:
a bot having a reactive system that generates a natural language interface for user interaction with a file hosting service and, in response to detected user inputs through the natural language interface indicative of a desired action, identifies a file hosting service to interact with, of a plurality of different file hosting services, identifies steps to perform to accomplish the desired action in the identified file hosting service, and interacts with an interface exposed by the identified file hosting service to perform the steps, the bot having a proactive system that proactively generates proactive user interface information for surfacing to the user; and
a bot connection system that is configured to connect the bot with a communication channel on a client system.

19. The bot messaging system of claim 18 and further comprising:
bot handoff logic configured to access specialized bot mappings, that map steps to specialized bots, and hand off processing of the desired action to an identified specialized bot, based on the steps and the specialized bot mappings.

20. The bot messaging system of claim 19 wherein the reactive system of the bot further comprises:
other system interaction logic configured to detect that the desired action includes one or more steps to be performed in another system, other than the file hosting service, and to interact with an interface exposed by the other system to perform the one or more steps.
